(19) United States
(12) Patent Application Publication
(10) Pub. No.: US 2026/0148150 A1
(43) Pub. Date: May 28, 2026

(54) Energy System Analysis, Planning, Installation Scheduling, and Management

(71) Applicant: GeoSolar Technologies, Inc., Denver, CO (US)

(72) Inventor: Daniel Edward Chartock, Hasbrouck Heights, NJ (US)

(21) Appl. No.: 18/963,006

(22) Filed: Nov. 27, 2024

(51) Int. Cl. G06Q 10/0631

(52) U.S. Cl. CPC G06Q 10/06311

(57) ABSTRACT

Methods and systems for environmental analysis and energy system planning, installation scheduling, and management are provided. An energy monitoring system can create jobs, including analyzing job information to determine services, estimate costs, and estimate completion time. The energy monitoring system can perform a bidding process according to an initial schedule, recommended bid prices, and the like, and the energy monitoring system can select and schedule contractors according to prerequisites, client availability, and contractor availability. The energy monitoring system can track jobs to ensure prerequisites are met and jobs are completed according to schedule and update the schedule as needed. The energy monitoring system further supports financing, rebates, and incentives, enabling a management entity to provide services, and monitoring systems to recommend operation adjustments, new services, and replacement services.

### TECHNICAL FIELD

The present disclosure relates generally to methods and systems for environmental analysis and energy system analysis, planning, installation scheduling, and management.

### BACKGROUND

An increasing number of customers are considering environmental impacts they cause, including energy consumption and pollution of owned buildings. Building construction and renovation projects to reduce environmental impacts have thus become progressively popular, such as the installation of alternative energy generation (e.g., solar panels, windmills, water mills, etc.), electric vehicle chargers, local energy storage, heat pumps, energy efficient appliances, energy efficient lighting, and the like. These construction and renovation projects can require analysis, planning, design, installation, scheduling, and management. Installed systems can also degrade over time or otherwise begin performing in an inefficient manner.

Building construction and renovation projects also include many different services with prerequisites, having certain conditions or benchmarks that must be completed for other services before the service with prerequisites can be completed. For example, framing may need to be performed before roofing, electrical work may preferably be completed before installation of walls, etc. Thus, jobs need to be scheduled to allow for any prerequisite work to occur before the jobs with the prerequisites. Different contractors and entities may otherwise unnecessarily have to make multiple trips to job sites at different times. Without proper scheduling, there will be an inefficient use of labor, leading to increased costs and project time.

In addition to scheduling jobs based on prerequisites, the various jobs may need to be bid on by contractors or subcontractors who may have varying availability and the price submitted in their bid. Determining, managing, and scheduling contractors and subcontractors based on submitted bids and their availability can further increase the difficulty of properly scheduling jobs to meet all prerequisites in a reasonable time for the customer.

### SUMMARY

Environmental analysis and energy system planning, installation scheduling, and management may be provided. In some embodiments, and by non-limiting example, a method comprises determining a plurality of services for a client; determining an initial schedule to perform the plurality of services based at least in part on an availability of the client; performing a bidding process to assign one or more contractors to the plurality of services, the bidding process comprising: enabling a plurality of contractors to submit bids for the plurality of services, evaluating received bids based at least in part on contractor availability and the initial schedule, and assigning the one or more contractors to the plurality of services based on the evaluation; determining a schedule for the one or more contractors to complete the plurality of services; and monitoring the status of the plurality of services.

Determining the schedule for the one or more contractors can comprise determining one or more prerequisites for the plurality of services and determining the schedule so the one or more prerequisites will be satisfied. In some embodiments, performing the bidding process further comprises recommending to the one or more contractors to submit bids for the plurality of services based at least in part on the contractor availability. Determining the plurality of services for the client can comprise receiving client information and building information; determining one or more recommended services based on the client information and the building information, wherein the client is operable to select the plurality of services from any one of (i) the one or more recommended services, (ii) one or more available services, or (iii) both (i) and (ii); and receiving authorization from the client to proceed with the plurality of services.

In certain embodiments, monitoring the status of the plurality of services comprises requesting an update from a contractor of the one or more contractors to indicate a milestone has been completed; receiving evidence to show the milestone has been completed from the contractor; and evaluating the evidence. When determining the evidence does not indicate the milestone has been completed, the method can further comprise determining a service cannot be performed until the milestone is completed; and adjusting the schedule so the milestone is scheduled to be completed before the service is scheduled to be performed. The evidence is (i) a photograph, (ii) a video, or (iii) both (i) and (ii) in example implementations.

The method can further comprise monitoring one or more installed systems associated with the client; and based on the monitoring, (i) recommending an adjustment to operation of an installed system of the one or more installed systems, (ii) recommending installation of a new system, (iii) recommending replacement of an existing system of the one or more installed systems, or (iv) any combination of (i)-(iii). In further embodiments, determining the plurality of services for the client further comprises maintaining real-time information of available financing offers and rebate offers; sharing the real-time information of available financing offers and rebate offers with the client; and receiving one or more selections of financing offers and rebate offers associated with the plurality of services. In yet further embodiments, determining the plurality of services for the client comprises receiving job information; determining one or more recommended service parameters based on the job information; estimating costs and a completion time based on the one or more recommended service parameters; proposing the one or more recommended service parameters, the costs, and the completion time to the client; and receiving approval from the client.

In another aspect, a system comprises a memory storage and a processing unit coupled to the memory storage, wherein the processing unit is operative to: determine a plurality of services for a client; perform a bidding process to assign one or more contractors to the plurality of services, the bidding process comprising to: enable a plurality of contractors to submit bids for the plurality of services, evaluate received bids based at least in part on contractor availability and an availability of the client, and assign the one or more contractors to the plurality of services based on the evaluation; determine a schedule for the one or more contractors to complete the plurality of services; and monitor the status of the plurality of services.

To determine the schedule for the one or more contractors can comprise to determine one or more prerequisites for the plurality of services; and determine the schedule so the one or more prerequisites will be satisfied. In some embodiments, to perform the bidding process further comprises to recommend to the one or more contractors to submit bids for the plurality of services based at least in part on the contractor availability. In example implementations, to determine the plurality of services for the client comprises to receive job information; determine one or more recommended service parameters based on the job information; estimate costs and a completion time based on the one or more recommended service parameters; propose the one or more recommended service parameters, the costs, and the completion time to the client; and receive approval from the client. In some embodiments, to monitor the status of the plurality of services comprises to request an update from a contractor of the one or more contractors to indicate a milestone has been completed; receive evidence to show the milestone has been completed from the contractor; and evaluate the evidence.

In a further aspect, an energy management system comprises a job creation engine operable to determine a plurality of services for a client; a job assignment engine operable to: perform a bidding process to assign one or more contractors to the plurality of services, the bidding process comprising to: enable a plurality of contractors to submit bids for the plurality of services, evaluate received bids based at least in part on contractor availability and an availability of the client, and assign the one or more contractors to the plurality of services based on the evaluation; and determine a schedule for the one or more contractors to complete the plurality of services; and a job tracking engine operable to monitor the plurality of services.

To determine the schedule for the one or more contractors can comprise to determine one or more prerequisites for the plurality of services; and determine the schedule so the one or more prerequisites will be satisfied. In certain embodiments, to perform the bidding process further comprises to recommend to the one or more contractors to submit bids for the plurality of services based at least in part on the contractor availability. To determine the plurality of services for the client can comprise to receive job information; determine one or more recommended service parameters based on the job information; estimate costs and a completion time based on the one or more recommended service parameters; propose the one or more recommended service parameters, the costs, and the completion time to the client; and receive approval from the client. In some embodiments, to monitor the plurality of services comprises to: request an update from a contractor of the one or more contractors to indicate a milestone has been completed; receive evidence to show the milestone has been completed from the contractor; and evaluate the evidence.

### BRIEF DESCRIPTION OF THE DRAWINGS

The accompanying drawings, which are incorporated in and constitute a part of this disclosure, illustrate various embodiments of the present disclosure. In the drawings:

FIG. 1 is a block diagram of an operating environment for automatically analyzing, planning, designing, scheduling, and managing jobs in accordance with aspects of the present disclosure.

FIG. 2 is an illustration of a building for analyzing, planning, designing, scheduling, and managing jobs in accordance with aspects of the present disclosure.

FIG. 3 is an illustration of a client profile creation Graphical User Interface (GUI) in accordance with aspects of the present disclosure.

FIG. 4 is an illustration of a client management GUI in accordance with aspects of the present disclosure.

FIG. 5 is an illustration of a second client management GUI in accordance with aspects of the present disclosure.

FIG. 6 is an illustration of a contractor profile creation GUI in accordance with aspects of the present disclosure.

FIG. 7 is an illustration of a contractor management GUI in accordance with aspects of the present disclosure.

FIG. 8 is an illustration of a management entity GUI in accordance with aspects of the present disclosure.

FIG. 9 is an illustration of a contractor bidding GUI in accordance with aspects of the present disclosure.

FIG. 10 is an illustration of a contractor update GUI in accordance with aspects of the present disclosure.

FIG. 11 is a flow chart of a method for analyzing, planning, designing, scheduling, and managing jobs in accordance with aspects of the present disclosure.

FIG. 12 is a flow chart a method for determining recommended service parameters, estimating costs, and proposing recommended services and costs in accordance with aspects of the present disclosure.

FIG. 13 is a flow chart of a second method for analyzing, planning, designing, scheduling, and managing jobs in accordance with aspects of the present disclosure.

FIG. 14 is a flow chart of a method for monitoring and managing systems in accordance with aspects of the present disclosure.

FIG. 15 is a block diagram of a computing device in accordance with aspects of the present disclosure.

FIG. 16 is a block diagram of a communications device in accordance with aspects of the present disclosure.

### DETAILED DESCRIPTION

Both the foregoing summary and the following detailed description are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Methods and systems are described herein for environment analysis and energy system planning and design, installation scheduling, and management. Determining the systems to install at a building can be challenging for a client, such as when trying to maximize an available budget to install systems for reducing energy consumption, generating clean energy, reducing pollution, and so on. Additionally, once a client selects the services (e.g., systems to be installed), the client may have limited availability for the installation of the systems and/or for other services to be performed. This issue is further exacerbated by the difficulty to coordinate the various contractors hired to perform the services, including when certain portions of services may have perquisites. For example, certain services may require other work be completed by other contractors to satisfy the prerequisite before the work on that service can proceed. Thus, contractors may need to be incentivized to perform work according to a desired schedule and be coordinated to perform services in an efficient manner to meet client needs, save money, address prerequisite work, and so on. As work progresses, contractors may not be able to fulfill services according to the original schedule, so monitoring of work progress and updating schedules as needed can also be necessary.

Services can have associated financing offers, rebate and incentive offers, and/or the like. These offers can change and vary by location. Thus, monitoring the available financing offers, rebate and incentive offers, and so on can enable clients to utilize deals the client qualifies for. A client with systems installed for enhanced control of energy production and usage may also desire information on the operation of the systems. Therefore, monitoring the operation of systems to recommend adjustments to the operation of systems, installation of new systems, and replacement of existing systems can be provided so clients can utilize systems effectively and efficiently.

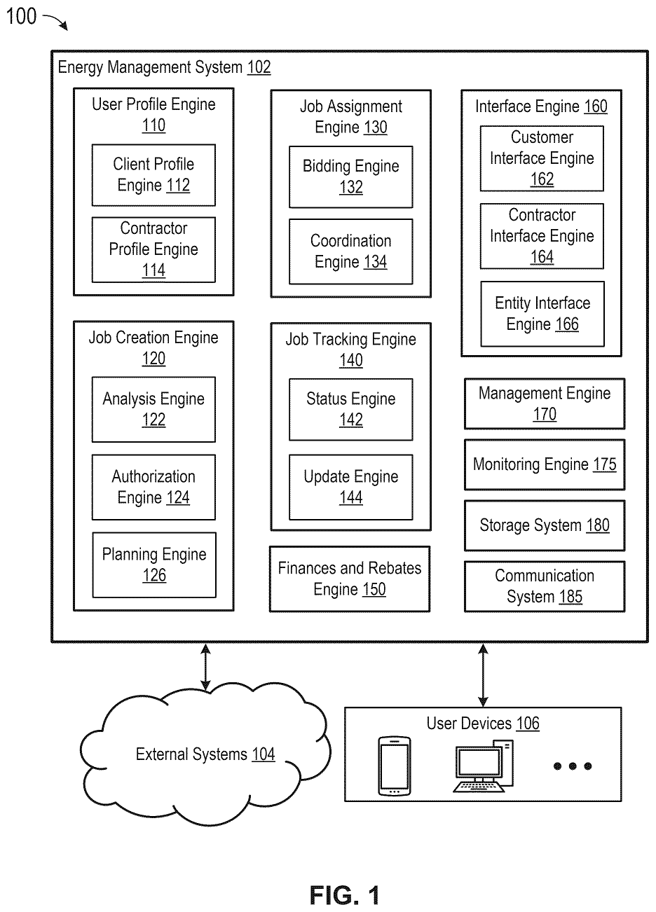

FIG. 1 is a block diagram of an operating environment 100 for automatically analyzing, planning, designing, scheduling, and managing jobs. Jobs can include construction jobs and renovation jobs, such as the installation of systems to reduce environmental impacts caused by a building. The systems can be installed in any building, such as a house, an apartment complex, a store, a warehouse, and/or other structures. The operating environment 100 includes an energy management system 102 that can enable users, such as a managing entity, contractors, subcontractors, clients, and the like, to create and manage jobs, bid on jobs, schedule jobs, track job progress, finance jobs, perform energy audits, monitor and manage systems, and/or the like. Contractors can be any entity that can provide a service to clients, including contractors, subcontractors, management entity employees, etc.

The energy management system 102 can communicate with one or more external systems 104 to exchange information, perform distributed processing steps, and/or the like. The external systems 104 can include storage systems (e.g., databases), computers, servers, sensors, and/or the like. For example, the external systems 104 can include a database of clients, a database of contractors, a database of services, sensors for monitoring systems, etc. The energy management system 102 can also communicate with one or more user devices 106 to enable users to receive data and input data associated with analyzing, planning, designing, scheduling, and managing jobs, monitoring and managing systems, and/or the like. One or more engines (i.e., components, subsystems) of the energy management system 102 may enable services of the energy management system 102. FIG. 1 illustrates an embodiment of various engines for the energy management system 102 to perform operations, but the energy management system 102 and/or other systems may perform the same or similar functions with a different combination of systems, engines, and/or the like.

The energy management system 102 can be associated with or otherwise controlled by a management entity. The management entity can manage clients and contractors to fulfill jobs for clients, such as construction and renovation services for a building. The management entity can track current jobs to ensure the jobs are being completed according to schedule, manage client support, manage contractor support, manage financing (e.g., payments submitted by clients, payments remitted to contractors), manage client feedback, and/or the like. The management entity can adjust the operation of the energy management system 102 as needed or otherwise desired to support fulfillment of jobs according to a determined schedule.

The energy management system 102 includes a user profile engine 110. The user profile engine 110 can facilitate the creation and management of user profiles to utilize the services of the energy management system 102. The user profile engine 110 can comprise the client profile engine 112 and the contractor profile engine 114. The client profile engine 112 handles the creation and management of user profiles for clients with construction projects, renovation projects, systems for monitoring and managing, and/or the like. The client profile engine 112 can determine the information to collect from a new client creating a profile, request the information from the client, ensure the received information reaches the intended destinations (e.g., storage systems), enable updating information after profile creation, and/or the like. The contractor profile engine 114 manages the creation of user profiles for contractors. The contractor profile engine 114 can determine the information to collect from a contractor creating a profile, request the information from the contractor, ensure the received information reaches the intended destinations (e.g., storage systems), enable updating information after profile creation, and/or the like.

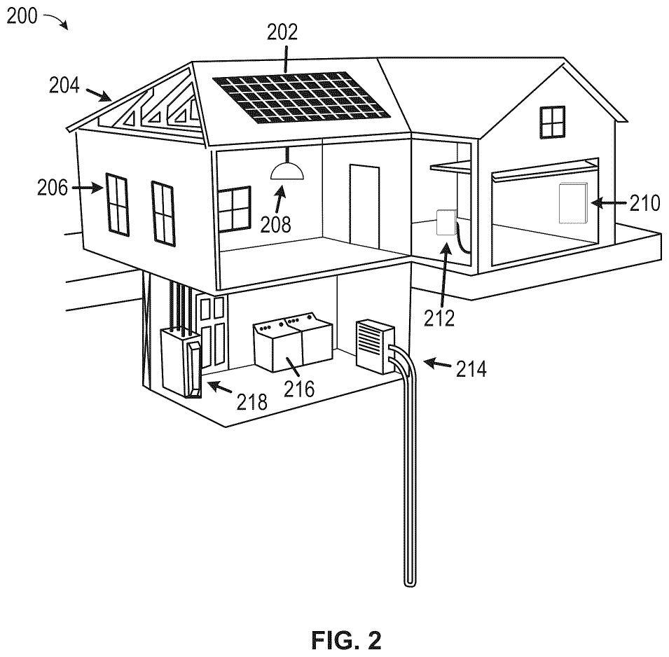

The energy management system 102 further comprises a job creation engine 120. The job creation engine 120 creates jobs associated with client requests for completion by contractors registered with the energy management system 102. The job creation engine 120 includes an analysis engine 122 that can use information from the client associated with a building being constructed or renovated and other information about the building to determine recommended services. For example, FIG. 2 is an illustration of a building 200 for analyzing, planning, designing, scheduling, and managing jobs in accordance with aspects of the present disclosure. The building 200 may be a house owned by a client that registered with the energy management system 102, and the client may be planning to construct or renovate the building 200.

The analysis engine 122 may receive or otherwise access information (e.g., retrieving information from external systems 104) associated with the building, such as square footage, the expected occupancy, what the building 200 will be used for (e.g., as a primary residence), the weather averages in the area, the floorplan, roof information, duct information, and/or the like. The analysis engine 122 may also receive information associated with the client that owns the building 200, such as whether the client owns or plans to own an electric vehicle, the services the client is requesting, the services the client may be interested in, whether the client desires to reduce energy usage and/or pollution, budget information, scheduling information (e.g., time constraints, availability for services to be completed, etc.), and/or the like. The analysis engine 122 can receive the information from one or more external systems 104 (e.g., retrieving weather information from a weather service) and/or one or more user devices 106 (e.g., the client's smartphone, personal computer, tablet, etc.). The analysis engine 122 can then create a recommendation of services to be included for the job being created for the building 200 based on the information about the building 200 and the client. For example, the analysis engine 122 can include all the services the client requested and consider recommending services the client may be interested in based on the client information and/or building 200 information. In an example implementation, the analysis engine 122 may determine the building is located in an area with sufficient yearly sunlight to save the client money and/or reduce pollution by installing solar panels, so the analysis engine 122 may also recommend the installation of solar panels. The analysis engine 122 can also use the client information and/or building information to recommend the sizing, type of solar panels, installation location, and the like for the recommended installation of solar panels. Furthermore, the analysis engine 122 can estimate the cost to install the solar panels based on the sizing, type of solar panels, and/or other characteristics of the associated service.

As illustrated in FIG. 2, the analysis engine 122 may recommend the installation of solar panels 202, an efficient building envelope 204 (e.g., insulation), energy efficient windows 206 (e.g., high level of insulation), energy efficient lighting 208 (e.g., LEDs), a local energy storage 210, an electric vehicle charger 212, a geothermal Heating, Ventilation, and Cooling (HVAC) system 214 (e.g., a heat pump), energy efficient appliances 216, and an air quality system 218 (e.g., air purification, humidifier, dehumidifier, etc.). The analysis engine 122 can use building information (e.g., location, roof size, square footage, etc.) and/or client information (e.g., budget information, scheduling information, etc.) to tailor the recommended services to the building 200. For example, the analysis engine 122 can determine the type, amount, and position of solar panels 202 to generate a desired amount of energy, the amount and type of insulation and/or the like for the efficient building envelop 204, the type, size, and amount of energy efficient windows 206, the type and amount of energy efficient lighting 208, the size of the local energy storage 210 to be effectively meet the energy needs of the building 200, determine the type of electric vehicle charger 212 to effectively charge the electric vehicle associated with the building, the type and size of the geothermal HVAC system 214 that can heat and cool the building 200 effectively, the type and characteristics of the energy efficient appliances 216 (e.g., a refrigerator sized to fit in the desired location in the building 200, washing machine sized to fit in the desired location in the building, etc.), the type, size, and components of the air purification system 218, and so on. The analysis engine 122 can then determine estimated costs based on the determined recommendations and estimated time to complete the recommended services. The analysis engine 122 may generate a recommendation to install the recommended systems if they are not yet present, replace the systems if they are faulty or can be otherwise upgraded, and/or the like.

Referring back to FIG. 1, the job creation engine 120 also includes an authorization engine 124 and a planning engine 126. The authorization engine 124 can submit the recommended services to the client for review and approval. The authorization engine 124 can include the estimated costs and estimated time to complete the recommended services in the proposal to the client. The client can authorize and reject the various recommended services, add additional services, and/or the like to finalize the services that will be completed for the job being created. The analysis engine 122 can revise the recommended services, re-tailor the recommended services to the building, re-estimate costs, and re-estimate the completion time based on the input provided by the user.

Once the services are finalized by the authorization engine 124, the planning engine 126 determines one or more initial schedules to complete the services in an order such that any milestones (e.g., prerequisites) are met, according to the desired timeline of the client, and/or the like. For example, installing the wiring in the walls for the solar panels 202, the local energy storage 210 and the electric vehicle charger 212 may be completed at the same time for efficiency. Similarly, the installation of the geothermal HVAC system 214 and the air quality system 218 may have prerequisites or may otherwise be efficiently installed at the same time. Additionally, the client may have selected dates that the client can be able to allow contractors access to the building that will minimize the interference of the client's schedule. The planning engine 126 may develop the initial schedule to reduce costs from contractors (e.g., by efficiently scheduling the contractors so less time is spent), reduce the total time to complete all services included in the job, indicate estimated dates to complete services during the bidding process, and/or the like.

The energy management system 102 also includes a job assignment engine 130. The job assignment engine 130 handles assigning the various services of a job to contractors registered with the energy management system 102. The job assignment engine 130 can include a bidding engine 132 for enabling services to be bid on by contractors. The bid opportunities can include information associated with the service, such as the location of the building, the estimated dates the service will be completed in (e.g., as determined using the initial schedule the planning engine 126 generated), and/or the like. A contractor registered with the energy management system 102 can submit a bid for a service the contractor wishes to complete. The bid can include a price for completion of the service, the contractor's availability to complete the service, and/or the like. In some embodiments, the bidding engine 132 can determine a recommended bid price for the associated service to help contractors determine an appropriate bid. The recommended bid may be based on the dates the contractor can complete the service in example implementations. For example, if the contractor can complete the service according to the initial schedule or otherwise on the dates or close to the dates desired by the client, the energy management system 102 will effectively offer more money to the contractor by recommending a higher bid. Thus, contractors are incentivized to perform services according to the desired schedules of clients, initial schedules, and/or the like so all services are completed as quickly as possible or otherwise in an efficient manner.

When enough bids are input by contractors, a timer for the job expires (e.g., twenty-four hours after the service is enabled to be bid on), or the energy management system 102 otherwise determines to select a winning bid, the bidding engine 132 can evaluate the submitted bids and automatically select contractors for each service of a job. The bidding engine 132 can select the contractors based on the submitted price, the contractor's availability, the contractor's qualifications to complete the service, and/or the like. In some embodiments, the managing entity may select the contractors based on the bids.

The job assignment engine 130 can also include a coordination engine 134. Once the bidding engine 132 selects the contractors for each service of a job, the coordination engine 134 can determine a schedule to coordinate the various contractors. The coordination engine 134 can use the one or more initial schedules developed by the planning engine 126 or create a schedule to ensure services are completed in an order such that any prerequisites are met. The coordination engine 134 can also use the availabilities indicated by the contractors to determine when contractors are available to complete the services according to the schedule. The coordination engine 134 can alter a schedule or select another schedule to use to complete the services based on the availability of the contractors. Thus, the coordination engine 134 assigns contractors to complete the services at determined dates and times to complete services for prerequisites and to complete the services as quickly as possible or otherwise efficiently.

The energy management system 102 additionally includes a job tracking engine 140 with a status engine 142 and an update engine 144. The job tracking engine 140 is operable to track jobs as scheduled by the job assignment engine 130 and request updates. The status engine 142 is operable to determine the status of services for a job. For example, the status engine 142 can determine status for various services at the building 200 to be wiring for the solar panels 202 completed with installation scheduled at a future date and time, the installation of the building envelope 204 to be scheduled, the installation of the energy efficient windows 206 has been rescheduled to a future date and time after the contractor was not able to arrive during the originally scheduled date, the installation of energy efficient lighting 208 completed, the installation of the local energy storage 210 delayed until the system is back in stock, etc. The job tracking engine 140 can share the status of the services with the associated client and the contractors so the contractors can manage updates to the schedule.

The update engine 144 can update the schedule based on the status of the various services. The update engine 144 can use the status determined by the status engine 142 to update schedules as needed, such as to reschedule the installation of the energy efficient windows 206, to wait to reschedule the installation of the local energy storage 210 until the system is in stock, etc. The update engine 144 can also request milestone updates from contractors to determine the present status of services. For example, the update engine 144 can request milestone updates for evidence of the completion of prerequisites to other services scheduled, points of failure, and/or other checkpoints. The update engine 144 can determine whether the prerequisites have been fulfilled using the updates and modify schedules accordingly. For example, if a contractor responds to an update with an indication that the prerequisites for a dependent service was not completed, the update engine 144 can determine to reschedule the dependent service to a date after the prerequisites can be completed. The update requests will be described in more detail herein.

The energy management system 102 also includes a finances and rebates engine 150. The finances and rebates engine 150 can manage providing financing services to clients, managing payments from clients, managing payments to contractors, and so on. The finances and rebates engine 150 can keep an updated list of available rebates for any service area, such as by communicating with one or more external systems 104. The rebates can include rebates and incentives offered nationally, by the state, locally, by non-profits, by manufacturers, by third parties, by the managing entity, and so on. Similarly, the finances and rebates engine 150 can offer financing directly through the management entity or via partner entities (e.g., banks, credit unions, other financial entities). The finances and rebates engine 150 can keep financing offers up to date by communicating with one or more external systems 104 (e.g., systems associated with the partner entities) in example implementations. Additionally, the finances and rebates engine 150 can notify clients of when payments are due, the amount due for each payment, send reminders for payment, send alerts when a payment is overdue, and so on. The finances and rebates engine 150 can alert contractors when a payment is sent.

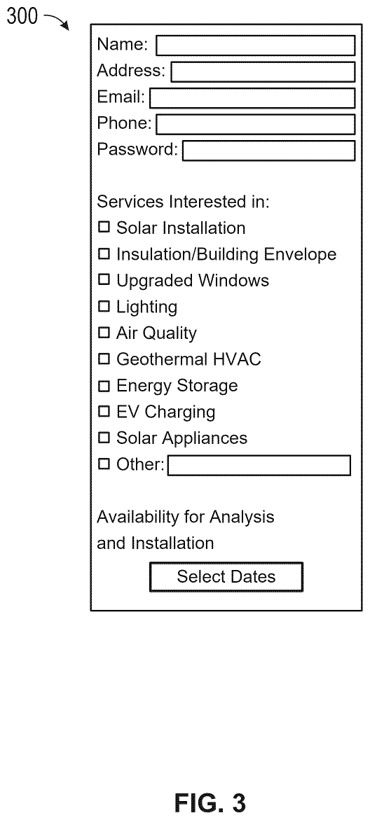

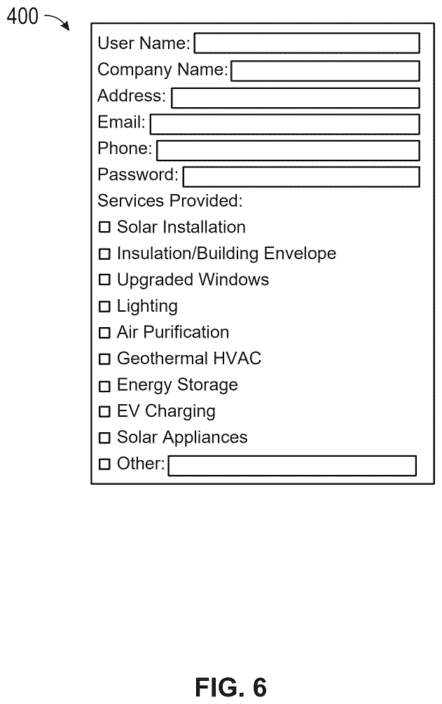

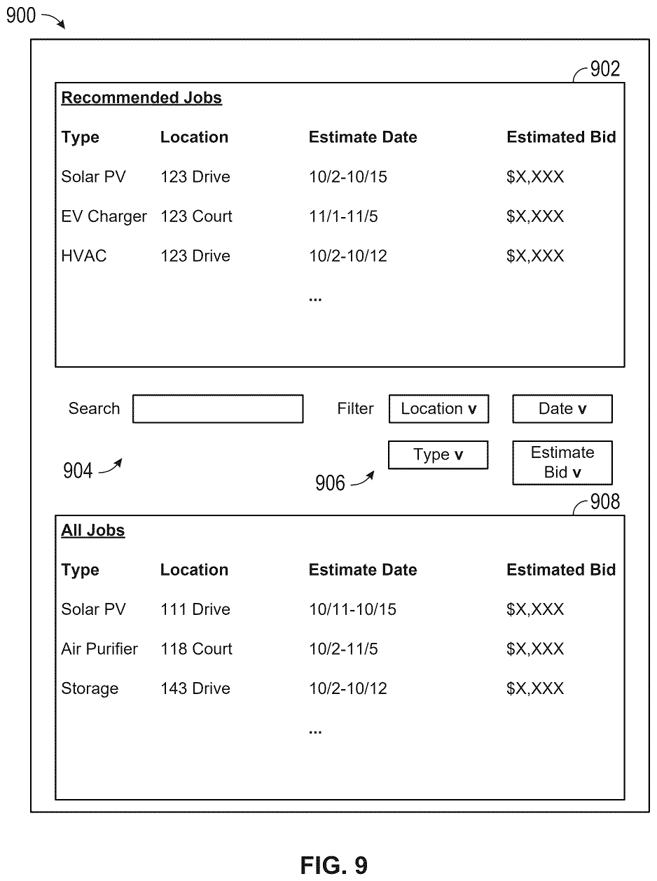

An interface engine 160 with a customer interface engine 162, a contractor interface engine 164, and an entity interface engine 166 can also be included in the energy management system 102. The interface engine 160 can manage providing data for the display of Graphical User Interfaces (GUIs) by devices, such as user devices 106, so the management entity, clients, and contractors can interact with the GUIs (e.g., input and other controls). The customer interface engine 162 can manage the GUIs displayed for clients, as will be described in more detail herein with respect to FIGS. 3-5. The contractor interface engine 164 can manage the GUIs displayed for contractors, as will be described in more detail herein with respect to FIGS. 6, 7, and 9. The entity interface engine 166 can manage the GUIs displayed for the management entity, as will be described in more detail herein with respect to FIG. 9.

The energy management system 102 further includes a management engine 170. The management engine 170 enable actions the managing entity determines to perform. For example, the management engine 170 can provide status updates for jobs (e.g., via the job tracking engine 140), automatically send status updates to clients (e.g., via email, push notifications, etc.), send status updates such as rescheduling updates to contractors, enable communication for submitted support tickets from clients and contractors, manage client and contractor profiles, manage partner entities, manage services that are offered, and/or the like.

A monitoring engine 175 can also be included in the energy management system 102. The monitoring engine 175 can enable users (e.g., clients) to monitor the operation of installed systems, such as alternative energy generation systems, electric vehicle chargers, local storage systems, HVAC systems, appliances, lighting, and so on. Based on the monitoring, the energy management system 102 can generate recommendations to increase energy efficiency. For example, the energy management system 102 can recommend altering how systems are used or otherwise operate, to install new systems, to replace systems, and the like. The users may communicate with the energy management system 102 to request the creation of jobs for the bidding, scheduling, and installation of new systems and/or the replacement of systems, to cause systems to adjust operation (e.g., according to the recommendations), and/or the like. The monitoring engine 175 can also enable energy audits. The monitoring engine 175 can use the information gathered by monitoring the systems of a client to perform an analysis of energy flows, such as energy consumption, in the client's building (e.g., the building 200). The energy audit can be used to recommend way to improve energy efficiency, including adjusting operation of systems, replacing systems, installing new systems, and/or the like.

The energy management system 102 can further include a storage system 180 and a communication system 185. The storage system 180 may store instructions for the operation of the energy management system 102, user profile information, other user information, job information, financing information, management information, energy audit information, monitoring information, and so on. The communication system 185 enables communication with local devices and/or remote devices, such as via a network. For example, the energy management system 102 can communicate with the external systems 104 and the user devices 106 using the communication system 185. The communication system 185 may include Wi-Fi capabilities, cellular capabilities, short range communication capabilities, and/or the like.

In certain embodiments, the energy management system 102 and its components, other devices in FIG. 1, and/or other devices described herein can utilize machine learning to perform environment analysis and energy system planning and design, installation scheduling, and management as described herein. For example, the analysis engine 122 can utilize machine learning to determine recommended services for a job, determine recommended installation parameters, estimate costs, and/or the like. The planning engine 126 can utilize machine learning to determine one or more possible schedules to complete the services in an order such that any prerequisites are met. The bidding engine 132 can utilize machine learning to determine bid recommendations and which bids to accept. The coordination engine 134 can utilize machine learning to determine a schedule for completing the services so any prerequisites are met and assigning contractors to dates and times according to the schedule. The job tracking engine 140 can utilize machine learning to readjust schedules and assigned dates and times based on the updates received, determine when to request updates, evaluate evidence (e.g., photo, video) submitted to confirm steps are completed in an update, and/or the like. The monitoring engine 175 can utilize machine learning to monitor systems, determine when systems are operating incorrectly or otherwise inefficiently, and determine when to recommend installation of a new system or replacement of a system.

In general, machine learning is directed to the design and the development of techniques that take data (e.g., network statistics, performance indicators) as input, and recognize complex patterns in the data. One common pattern among machine learning techniques is the use of an underlying model M, whose parameters are optimized for minimizing the cost function associated to M, given the input data. For example, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used to classify new data points. Often, M is a statistical model, and the cost function is inversely proportional to the likelihood of M, given the input data.

In various implementations, the energy management system 102 and/or other devices may employ one or more supervised, unsupervised, or semi-supervised machine learning models. Generally, supervised learning comprises the use of a training set of data that is used to train the model to apply labels to the input data. For example, the training data may include sample telemetry that has been labeled as being indicative of an acceptable performance or unacceptable performance. Unsupervised techniques do not require a training set of labels. While a supervised learning model may look for previously seen patterns that have been labeled as such, an unsupervised model may instead look to whether there are sudden changes or patterns in the behavior of the metrics. Semi-supervised learning models are a mixed approach that use a reduced set of labeled training data.

Example machine learning techniques that the energy management system 102 and/or other devices can employ may include Nearest Neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), Support Vector Machines (SVMs), Generative Adversarial Networks (GANs), Long Short-Term Memory (LSTM), logistic or other regression, Markov models or chains, Principal Component Analysis (PCA) (e.g., for linear models), Singular Value Decomposition (SVD), Multi-Layer Perceptron (MLP) Artificial Neural Networks (ANNs) (e.g., for non-linear models), replicating reservoir networks (e.g., for non-linear models, typically for timeseries), random forest classification, and/or the like.

In further implementations, the energy management system 102 and/or other devices may also use one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. Example generative approaches can include, but are not limited to, Generative Adversarial Networks (GANs), Large Language Models (LLMs), other transformer models, and/or the like.

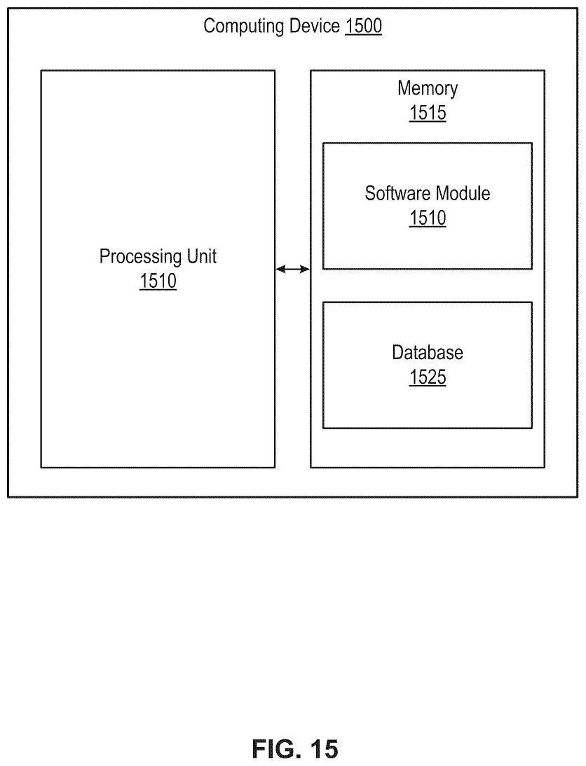

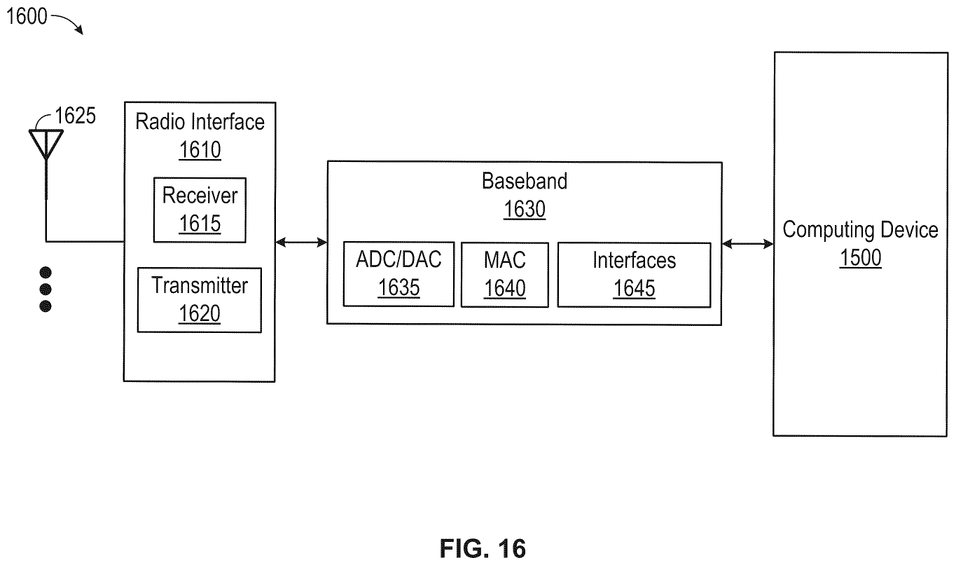

The elements described above of the operating environment 100 (e.g., the energy management system 102, the components of the energy management system 102, the external systems 104, the user devices 106, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 15 and 16, the elements of the operating environment 100 may be practiced in a computing device 1500 and/or communications device 1600.

The energy management system 102 can increase flexibility for recommending tailored services for a specific building, scheduling contractors to complete multiple services that may have prerequisites, monitoring the operation of systems to adjust operation of systems and recommend installation of new and replacement systems, and so on. The energy management system 102 can additional reduce search times for information and increase electronic processing of job information (e.g., building information, client information, etc.), such as to generate service recommendations, tailor the services to the associated building or job site, estimate costs for the tailored services, estimate completion times for the services, determine a schedule based on client availability, contractor availability, prerequisites, etc., adjusting the schedule as needed, providing real-time financing, rebate, and incentive offers, and so on.

FIGS. 3-9 are illustrations of example GUIs for automatically analyzing, planning, designing, scheduling, and managing jobs, monitoring and managing systems, and/or the like. The energy management system 102 can provide devices, such as the user devices 106, with the data to display the example GUIs and enable input and other controls via the example GUIs. Devices can use web browser, an application (e.g., an application made available by the managing entity), and/or the like to access the GUIs. The example GUIs may have different features, elements, formats, etc. in further embodiments.

FIG. 3 is an illustration of a client profile creation GUI 300 in accordance with aspects of the present disclosure. The energy management system 102 can communicate with a user device 106 associated with a new client for the user device 106 to display the client profile creation GUI 300 and enable the new client to create a profile. In example implementations, the client profile engine 112 determines the information to collect from the new client, and the customer interface engine 162 generates the client profile creation GUI 300 to request the information determined by the client profile engine 112. The client profile creation GUI 300 can include a name element to receive the client's name, an address element to receive the address of the building the client wants to construct, perform renovations for, and/or monitor, contact elements to receive contact information (e.g. email element, phone element), a password element to receive a password, a services selection element to receive information regarding services the client wants performed and/or may be interested in, an availability element for the client to indicate dates and times of availability for analysis of the building, performance of services, etc., and/or the like. The client may be able to update the information requested via the client profile creation GUI 300 in other GUIs in further embodiments.

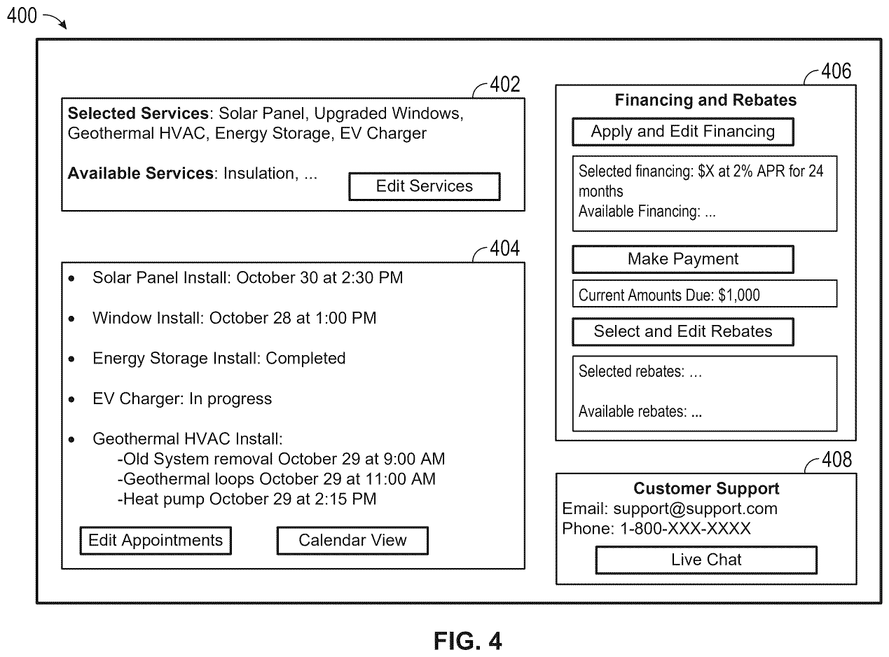

FIG. 4 is an illustration of a client management GUI 400 in accordance with aspects of the present disclosure. The client management GUI 400 can be displayed on a client's user device 106 for the client to manage services, track services, manage finances, contact support, and so on. For example, the customer interface engine 162 and/or other components of energy management system 102 exchange data with the client's user device 106 for display of and interaction with the client management GUI 400.

The client management GUI 400 includes a service management element 402, and the service management element 402 can include a list of selected services, a list of available services that can be selected via the energy management system 102, indication of services that are recommended, one or more inputs to edit services (e.g., select available services, request to reschedule services, remove services, etc.), and/or the like. The services can include installation services, maintenance services, energy audit and other analysis services, and/or the like. The job creation engine 120 can generate or otherwise provide information for the service management element 402 and updates jobs based on inputs received via the service management element 402.

The client management GUI 400 also includes a service schedule element 404. The service schedule element 404 can display a schedule of when contractors are scheduled to perform selected services and the status of service. The schedule can be a list view or a calendar view with an input to rotate between the views. The service schedule element 404 can also include inputs for editing the schedule, such as when the client needs to present but can no longer make the scheduled time, editing the client's availability for services not yet scheduled, and so on. The job tracking engine 140 can generate or otherwise provide the information for the service schedule element 404 and updates schedules based on the inputs from the client. In certain embodiments, a client may have multiple buildings associated with their account, so the client can specify services for each building via the service management element 402 and view schedules for each building via the service schedule element 404.

The client management GUI 400 further includes a finances management element 406. The finances management element 406 can include inputs for reviewing financing offers, available incentives, and available rebates, display selected financing options, incentives, and/or rebates, enable edits to select financing options and/or rebates, inputs for submitting payments, and/or the like. The client management GUI 400 also includes a customer support element 408, and the customer support element 408 can include contact information to reach support, inputs for chatting with a customer support representative, and so on. In example implementations, the client can report concerns about services being completed, the energy management system 102 can evaluate the report, and the energy management system 102 can adjust the schedule of the services as needed. For example, the energy management system 102 may determine a contractor did not complete a service that satisfies milestones (e.g., prerequisites) based on the client report. In other example implementations, the managing entity can evaluate the report and adjust the schedule as necessary.

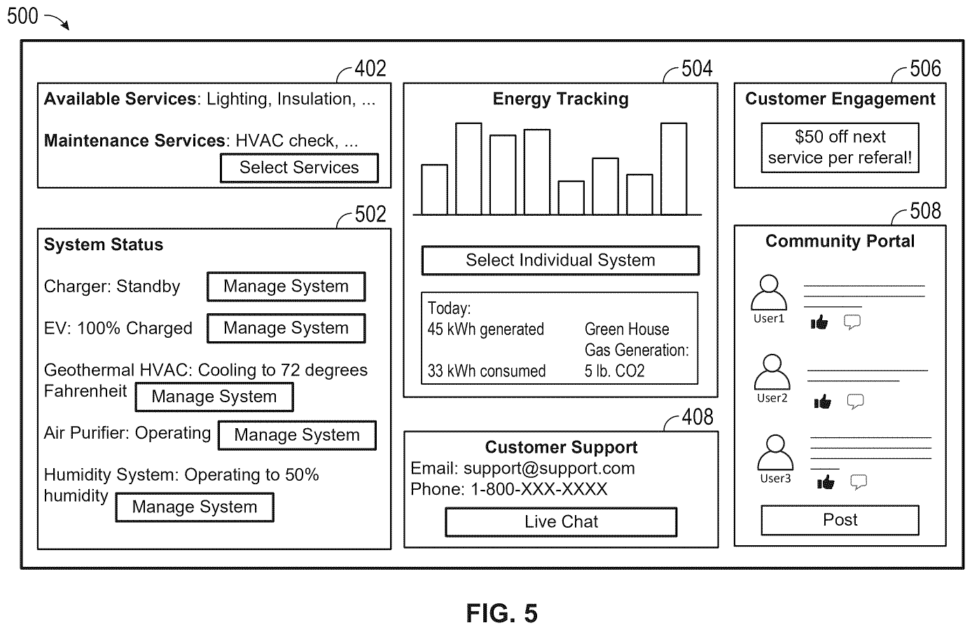

FIG. 5 is an illustration of a second client management GUI 500 in accordance with aspects of the present disclosure. The second client management GUI 500 can be displayed on a client's user device 106 for the client to manage services, monitor and manage systems, track energy usage, contact support, interact with customer engagement elements, interact with community portal elements, and so on. For example, the customer interface engine 162 and/or other components of energy management system 102 exchange data with the client's user device 106 for display of and interaction with the second client management GUI 500.

The second client management GUI 500 can include a monitoring and management element 502 for monitoring and managing systems. In example implementations, the monitoring and management element 502 can indicate the operating status of systems and include inputs for managing or otherwise adjusting the operation of the system. The monitoring and management element 502 for example can indicate an air purifier is operating and include an input for the client to turn off the air purifier, schedule when the air purifier will operate, and so on. The monitoring engine 175 may generate or otherwise provide the monitoring information and enable control of the systems.

The second client management GUI 500 also includes a customer engagement element 506. The management entity can utilize the customer engagement element 506 (e.g., via the management engine 170) to interact with clients, such as by asking for referrals, sending offers, and otherwise communicating with clients. The second client management GUI 500 can also include a community portal element 508. The community portal element 508 can show information submitted by other clients, include inputs for interacting with the information submitted by other clients, enable the client to create a post, and/or the like.

FIG. 6 is an illustration of a contractor profile creation GUI 600 in accordance with aspects of the present disclosure. The contractor profile creation GUI 600 can vary based on the type of contractor (e.g., primary contractor, subcontractor, management entity employee, etc.). For example, a management entity employee may have a higher level of access than outside contractors. The energy management system 102 can communicate with a user device 106 associated with a new contractor for the user device 106 to display the contractor profile creation GUI 600 and enable the new contractor to create a profile. In example implementations, the contractor profile engine 114 determines the information to collect from the new contractor, and the contractor interface engine 164 generates the contractor profile creation GUI 600 to request the information determined by the contractor profile engine 114. The contractor profile creation GUI 600 can include name elements to receive the contractor contact's name, the name of the contractor business, and/or the like, an address element to receive the address of the contractor, contact elements to receive contact information (e.g. email element, phone element), a password element to receive a password, a services element to indicate services the contractor can provide, and/or the like. The contractor may be able to update the information requested via the contractor profile creation GUI 600 in other GUIs in further embodiments.

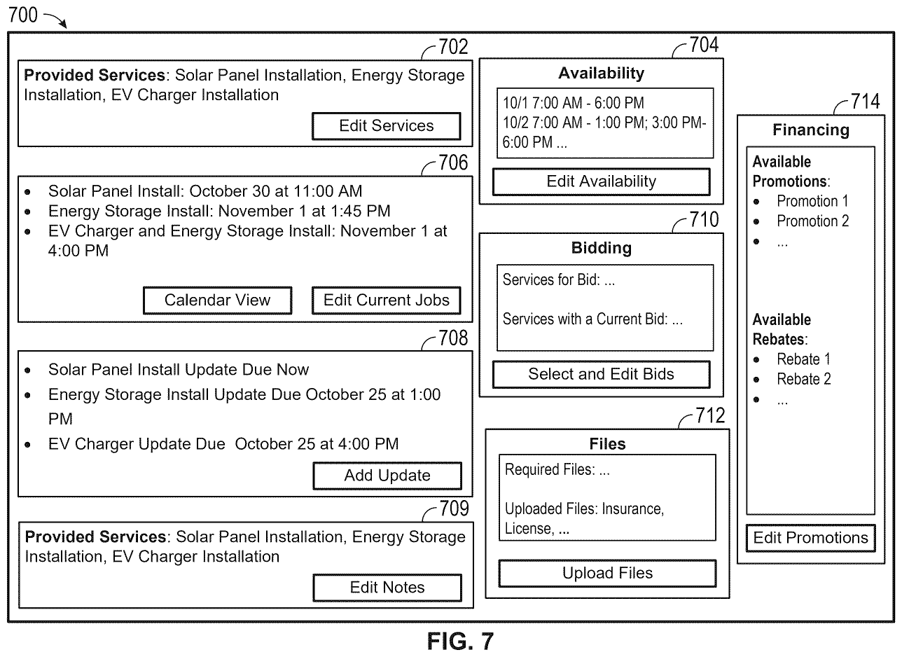

FIG. 7 is an illustration of a contractor management GUI 700 in accordance with aspects of the present disclosure. The contractor management GUI 700 can vary based on the type of contractor (e.g., primary contractor, subcontractor, management entity employee, etc.). For example, a management entity employee may have a higher level of access than outside contractors. The contractor management GUI 700 can be displayed on a contractor's user device 106 for the contractor to manage services, monitor and manage systems, track energy usage, contact support, interact with customer engagement elements, interact with community portal elements, and so on. For example, the contractor interface engine 164 and/or other components of energy management system 102 exchange data with the contractor's user device 106 for display of and interaction with the contractor management GUI 700.

The contractor management GUI 700 includes a provided services element 702 that indicates the services the contractor provides and inputs to edit the services the contractor provides. The contractor management GUI 700 also includes a contractor availability element 704. The contractor availability element 704 can show the contractor's indicated availability and include inputs for the contractor to edit the availability. A contractor schedule element 706 can include a schedule of when the contractor is scheduled to perform services, the location of the service, the status of service, and/or the like. The schedule can be a list view or a calendar view with an input to rotate between the views. The contractor schedule element 706 can also include inputs for editing the schedule.

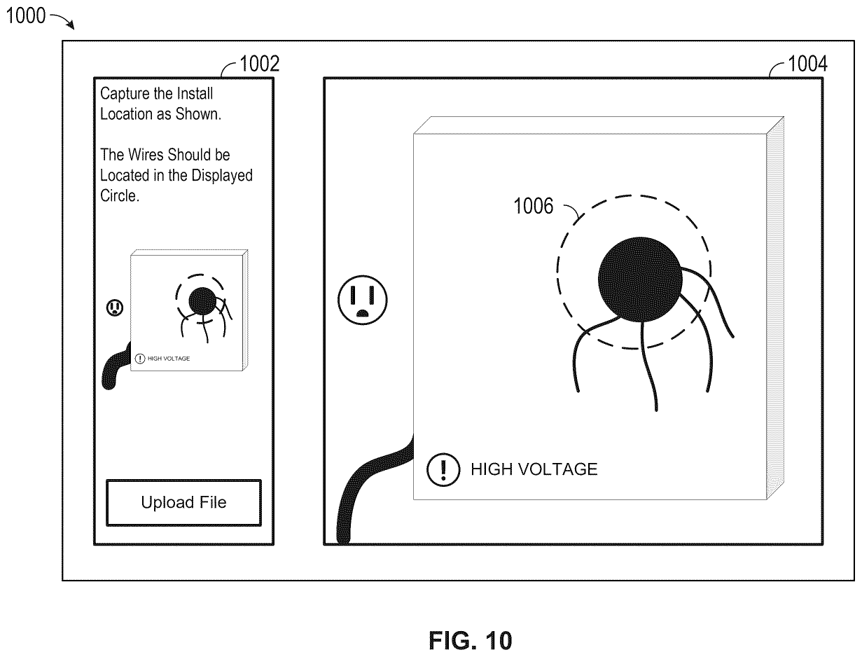

The contractor management GUI 700 can also include an update element 708 that indicates when to input information associated with progress updates for services. For example, the update element 708 can request updates in the form of indicating that one or more steps of a service (e.g., to meet prerequisites for other services) or the entire service is completed, evidence including photographic and/or video uploads showing the requested completion of the steps or entire service, and/or the like. In some embodiments, an employee of the management entity can review submitted evidence to determine whether an update's requirements have been met. In other embodiments, the energy management system 102 automatically evaluates the evidence to determine whether an update's requirements have been met. Uploading photographs and/or video when submitting an update will be described in more detail herein with respect to FIG. 10. When the contractor has not met the requirements for an update, the contractor can indicate one or more dates and times the contractor can complete the steps or entire service that the update is requesting.

A notes element 709 can include notes for jobs. The notes can be added and/or edited by the client, the managing entity, the contractor, other contractors working on another service at the same site and so on. The notes can include information for the contractors to complete the services, such as gate codes, lock bock information, parking areas, correspondence between contractors, and/or the like. Thus, the contractors may also communicate using the notes element 709 and/or using other services provided by the energy management system 102.

A bidding element 710 can include a list of services available for the contractor to submit a bid on, a list of services the contractor has bid on, inputs for submitting and editing bids, and so on. A more detailed bidding GUI will be described herein with respect to FIG. 9. A files element 712 can include a list of files the energy management system 102 is requesting, the files the contractor has uploaded, and inputs for uploading files and editing uploaded files. For example, the contractor may upload files indicating qualifications for completing the services the contractor indicates it can perform, insurance information, company information, and so on. The energy management system 102 can analyze the files the contractor uploads to automatically verify the contractor's qualifications, insurance coverage, and so on. The contractor management GUI 700 can also include a contractor financing element 714. The contractor can edit available financing offers, incentives, and/or rebates for the services the contractor provides using the contractor financing element 714.

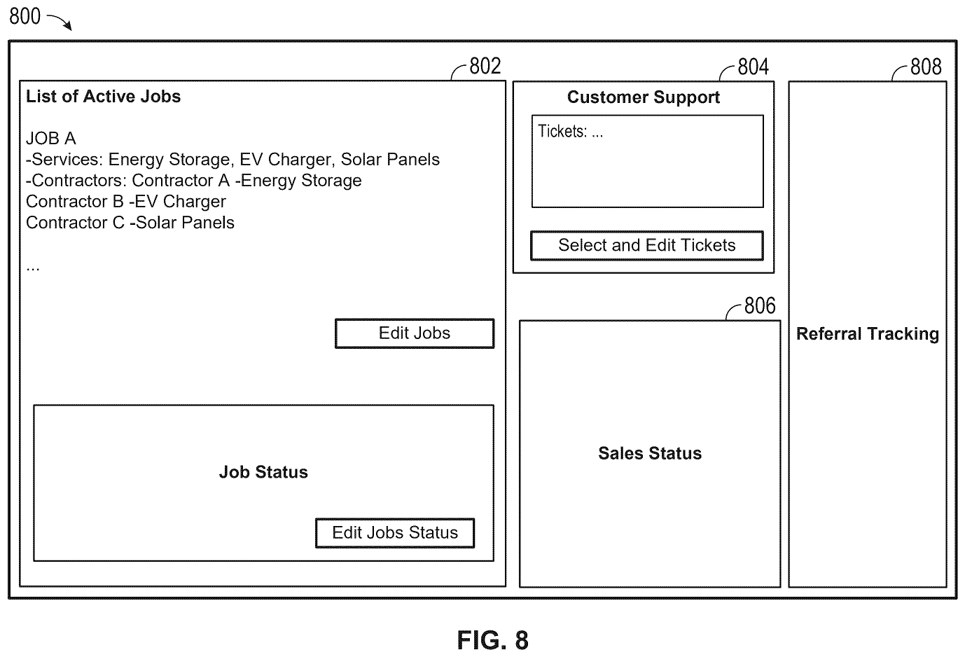

FIG. 8 is an illustration of a management entity GUI 800 in accordance with aspects of the present disclosure. The management entity GUI 800 can be displayed on a device associated with the management entity (e.g., management entity employee) for the entity to manage the energy management system 102, such as for managing active jobs, customer support, sales and financing management, referral tracking, and/or the like. For example, the entity interface engine 166 and/or other components of energy management system 102 exchange data with the management entity's device for display of and interaction with the management entity GUI 800.

The management entity GUI 800 can include a job element 802 for the management entity to manage jobs, such as reviewing active jobs, editing active jobs (e.g., modifying the schedules, modifying the contractors assigned to services, modifying financing, modifying pricing, etc.), reviewing job statuses, editing job statuses, and so on. A customer support element 804 can include a list of active support tickets submitted by clients and contractors and inputs to respond to tickets and otherwise manage tickets (e.g., mark as completed, delete tickets, set priority levels for tickets, notify employees to address tickets, etc.).

The management entity GUI 800 can also include a sales status element 806 and a referral tracking element 808. The sales status element 806 can track the sales of services for clients, such as to identify clients that have requested services, identify clients that may be open to recommendations for services, track financing and payments, and so on. The referral tracking element 808 can track referrals from clients and contractors to use the energy management system 102.

FIG. 9 is an illustration of a contractor bidding GUI 900 in accordance with aspects of the present disclosure. The contractor bidding GUI 900 can vary based on the type of contractor (e.g., primary contractor, subcontractor, management entity employee, etc.). For example, a management entity employee may have a higher level of access than outside contractors. The contractor bidding GUI 900 can be displayed on a contractor's user device 106 for the contractor to manage bids. For example, the contractor interface engine 164 and/or other components of energy management system 102 exchange data with the contractor's user device 106 for display of and interaction with the contractor bidding GUI 900.

The contractor bidding GUI 900 can include a recommended jobs element 902. The recommended jobs element 902 can include services the energy management system 102 recommends the contractor to bid on. The recommended jobs element 902 can show the characteristics of the recommended services, such as the type of service, the location, the estimated date for completing the service, a recommended bid price, and/or the like. In certain embodiments, the bidding engine 132 and/or other components of the energy management system 102 evaluates the characteristics of the contractor, such as services offered, qualifications (e.g., as authenticated via files uploaded via the files element 712), proximity to the location of the service site, previous bid prices for similar services, the availability of the contractor, and/or the like, to determine whether to recommend a service to the contractor. For example, the energy management system 102 compares the characteristics of the contractor to the characteristics of available services to bid on to determine recommended services. The contractor can select a recommended service and submit a bid using the recommended jobs element 902. The contractor can use a search function 904 to search for specific services recommended to be bid on using keywords, phrases, and so on. The contractor can also filter bids using filter functions 906, such as filtering by location, service type, date the service should be completed, the recommended bid price, and/or the like.

The contractor bidding GUI 900 can also include a jobs element 908 with all available jobs. The jobs element 908 can include all services available to be bid on, and the jobs element 908 can show the characteristics of the services available to be bid on. The contractor can select a recommended service and submit a bid using the recommended jobs element 902. The contractor can use the search function 904 to search for specific services to bid on and use the filter functions 906 to filter services available to be bid on. In some embodiments, the recommended jobs element 902 and the jobs element 908 may be combined, with recommended jobs being indicated as recommended in the single combined element.

FIG. 10 is an illustration of a contractor update GUI 1000. The contractor update GUI 1000 can include an instruction element 1002 and a live view element 1004. The instruction element 1002 can include instructions for submitting the update or otherwise describe what to submit in response to an update request. The instruction element 1002 can show an example figure of what to take a picture of when requesting a photo, include text describing what to take a photo of, and so on. For example, the instruction element 1002 may request a photo of the installation location of an electric vehicle charger with wires showing in an area indicated by a graphic 1006 displayed in the live view element 1004. The live view element 1004 can show a live view of a camera for the contractor to capture evidence according to the instructions in the instruction element 1002. In some embodiments, the instruction element 1002 may include inputs for uploading files, such as when the contractor has already captured photo evidence for submission.

The energy management system 102 can determine the instructions to include in the instruction element 1002 based on the schedule the job assignment engine 130 determined and/or as modified by the job tracking engine 140. For example, the energy management system 102 may identify that the service is scheduled to be completed or have reached a milestone, there is a prerequisite step that must be completed before another upcoming service that is scheduled can move forward, and/or the like. the energy management system 102 can determine the evidence to request from the contractor to confirm that the scheduled step or service is completed, the prerequisite step is completed, etc. When a contractor submits evidence, the energy management system 102 can analyze the evidence to determine whether the evidence confirms the contractor completed the necessary work. If the energy management system 102 determines the necessary work, the energy management system 102 (e.g., the update engine 144) can alter the schedule as needed or otherwise desired.

In some embodiments, the energy management system 102 can share submitted evidence, such as photos and videos, to other contractors. For example, a contractor may need to locate a wire another contractor installed and took a picture of to submit as evidence that the wire was installed. The energy management system 102 can share the picture of the installed wire with the contractor to assist the contractor in locating the wire. The energy management system 102 may also share evidence with the client in example implementations, such as to keep the client updated on the status of the services.

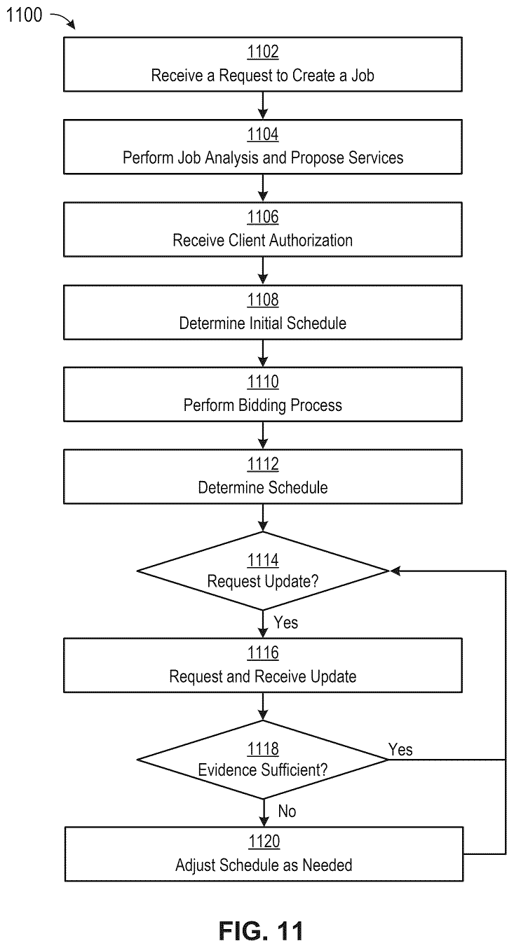

FIG. 11 is a flow chart of a method 1100 for analyzing, planning, designing, scheduling, and managing jobs in accordance with aspects of the present disclosure. The method 1100 can begin at operation 1102, and a request to create a job is received. For example, the energy management system 102 can receive the request from a client or another user, such as the management entity. The request can include information about the job, included services the associated client has selected, services the client is interested in, building information (e.g., location of the job, building characteristics, etc.), client information (e.g., budget information, scheduling information, etc.), and/or the like.

In operation 1104, a job analysis is performed and services are proposed. For example, the analysis engine 122 receive or otherwise access information (e.g., retrieving information from external systems 104) associated with the job, such as the information included in the request received in operation 1102, received from one or more external systems 104, one or more user devices 106, and so on. The analysis engine 122 determine services to be performed (e.g., including services to recommend for the job based on the information), tailor the services to the associated job site, estimate the cost for the services, and estimate the time to complete the services. In certain embodiments, the analysis engine 122 and/or other components of the energy management system utilize machine learning to determine the services of the job, tailor the services, estimates costs, and/or estimate the time to complete the services. The authorization engine 124 can then propose the services, such as to the client, including providing the tailored information (e.g., six solar panels installed at a specific location of the roof), providing cost estimates, and providing time to complete estimates.

In operation 1106, client authorization is received. For example, the client can authorize and reject the various recommended services, add additional services, and/or the like to finalize the services that will be completed for the job being created. The analysis engine 122 can revise the recommended services, re-tailor the recommended services to the building, re-estimate costs, and re-estimate the completion time based on the input provided by the user. Once the client has authorized all pending services, the method 1100 can proceed to operation 1108.

In operation 1108, an initial schedule is determined. For example, the planning engine 126 determines one or more initial schedules to complete the services in an order such that any prerequisites are met, according to the desired timeline of the client, and/or the like. The planning engine 126 may develop the initial schedule to reduce costs from contractors (e.g., by efficiently scheduling the contractors so less time is spent), reduce the total time to complete all services included in the job, indicate estimated dates to complete services during the bidding process, and/or the like. In example implementations, the initial schedule can be ranges of dates that will meet prerequisites, client timeline preferences, and/or the like. Thus, the initial schedule can be flexibly met when contractors are selected for completing services.

In operation 1110, a bidding process is performed. For example, the job assignment engine 130 (e.g., via the bidding engine 132) performs a bidding process to determine one or more contractors to complete the one or more services associated with the job. The job assignment engine 130 can provide bid information for services to be bid on, such as the type of service, the location where the service will be performed, recommended bid prices, approximate dates for completing the service based on the initial schedule determined in operation 1108, and so on. Contractors (e.g., primary contractors, subcontractors, managing entity employees, etc.) can then submit bids to complete a service. The bids can include a price for completion of the service, the contractor's availability to complete the service, and/or the like. The bidding engine 132 and/or the managing entity can select contractors from the submitted bids based on the submitted price, the contractor's availability, the contractor's qualifications to complete the service, and/or the like. In certain embodiments, the job assignment engine 130 uses machine learning techniques to provide bid information and/or select contractors based on the submitted bids.

In operation 1112, a schedule is determined. For example, the coordination engine 134 can determine a schedule to coordinate the various contractors. The coordination engine 134 can use the one or more initial schedules developed by the planning engine 126 or create a schedule to ensure services are completed in an order such that any prerequisites are met. The coordination engine 134 can also use the availabilities indicated by the contractors to determine when contractors are available to complete the services according to the schedule. The coordination engine 134 can alter a schedule or select another schedule to use to complete the services based on the availability of the contractors. Thus, the coordination engine 134 assigns contractors to complete the services at determined dates and times to complete services for prerequisites and to complete the services as quickly as possible or otherwise efficiently.

In decision 1114 it is determined whether an update should be requested. For example, the energy management system 102 can track the status of the services being performed for the job to manage the schedule. An update may be requested to determine whether a prerequisite has been fulfilled, a service has been completed according to the schedule, and/or the like. When it is determined to request an update, the method 1100 can proceed operation 1116, and an update is requested, such as via the update engine 144. The update request can include instructions for providing evidence to satisfy the update, such as photographic evidence. Once the update evidence is received from the relevant party, the method 1100 can proceed to decision 1118. In decision 1118, it is determined whether the evidence is sufficient. For example, the update engine 144 and/or the managing entity can review the submitted evidence to determine whether a prerequisite has been met, the service was completed according to schedule, and/or the like. If the evidence is not sufficient, the schedule can be adjusted as needed in operation 1120, such as to prevent contractors from trying to complete a service that has prerequisites that were not met yet. The method 1100 can then proceed back to decision 1114 to determine when further updates are needed. In some embodiments, the energy management system 102 can indicate to the relevant party that the evidence is insufficient and request further evidence before adjusting the schedule. If the evidence is determined to be sufficient in decision 1118, the method 1100 can proceed back to operation 1114 to determine when further updates are needed. The method 1100 can conclude when no further updates are needed, such as when the job is completed.

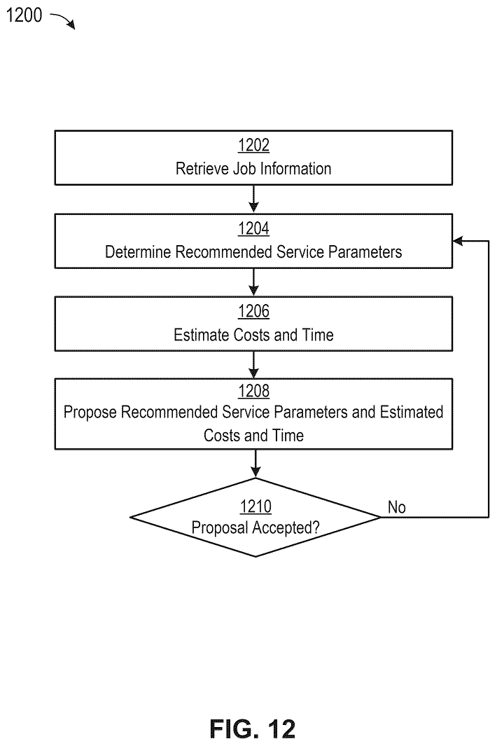

FIG. 12 is a flow chart a method 1200 for determining recommended service parameters, estimating costs, and proposing recommended services and costs. The method 1100, can utilize the operations of the method 1200 in some embodiments, such as to perform operation 1104 and operation 1106. The method 1200 may begin at operation 1202, and job information is received. For example, the job creation engine 120 can retrieve job information including client information (e.g., budgeting information, scheduling information), building information (e.g., location, size, roof characteristics, etc.), selected services, services the client is interested in, and so on. The energy management system 102 can retrieve the job information via one or more external systems 104, one or more user devices 106, the storage system 180, and/or the like.

In operation 1204, recommended service parameters are determined. For example, the analysis engine 122 tailors identified services based on the job information. The analysis engine 122 may utilize machine learning techniques to determine the recommended service parameters based on the job information. For example, the machine learning techniques can estimate energy usage of the associated building using the job information and determine an appropriate size for a storage system and a number of solar panels to install to meet the estimated energy usage.

In operation 1206, costs and time for completing the services are estimated. For example, the analysis engine 122 estimates the costs and time for completing the services based on the recommended service parameters. The analysis engine 122 can utilize machine learning techniques to estimate costs and times.

In operation 1208, the recommended service parameters and estimated costs and times are proposed, such as to the associated client. In decision 1210, it is determined whether the proposal is accepted. If the proposal is not accepted, the method 1200 can proceed to operation 1204 for modification of the recommended service parameters. estimates costs, and/or estimated times. In the proposal is accepted, the method 1200 can conclude.

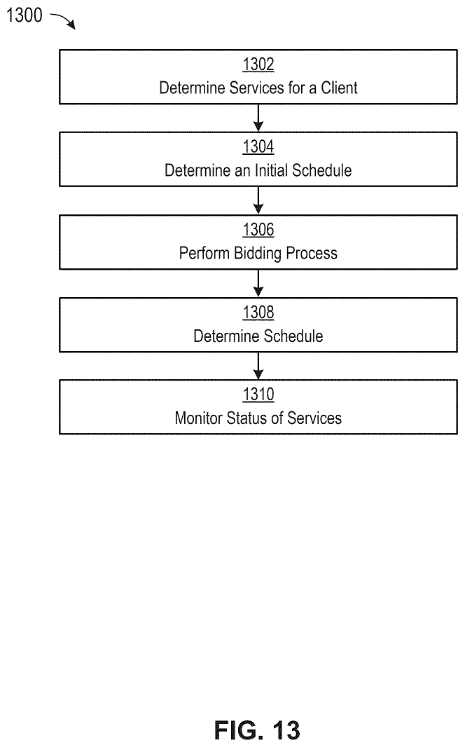

FIG. 13 is a flow chart of a second method 1300 for analyzing, planning, designing, scheduling, and managing jobs in accordance with aspects of the present disclosure. The method 1300 can include one or more of the operations of the method 1100 and/or the method 1200 in example implementations. The method 1300 can begin at operation 1302, and plurality of services are determined for a client. For example, the job creation engine 120 can determine the plurality of services for the client, for example according to the methods described above. Determining the plurality of services for the client can comprise receiving client information and building information, determining one or more recommended services based on the client information and the building information, wherein the client is operable to select the plurality of services from the one or more recommended services, one or more available services, and/or the like, and receiving authorization from the client to proceed with the plurality of services.

In certain embodiments, determining the plurality of services for the client comprises receiving job information, determining one or more recommended service parameters based on the job information, estimating costs and a completion time based on the one or more recommended service parameters, proposing the one or more recommended service parameters, the costs, and the completion time to the client; and receiving approval from the client. Determining the plurality of services for the client can comprise maintaining real-time information of available financing offers and rebate offers, sharing the real-time information of available financing offers and rebate offers with the client, and receiving one or more selections of financing offers and rebate offers associated with the plurality of services.

In operation 1304, an initial schedule to perform the plurality of services is determined based at least in part on an availability of the client. For example, the planning engine 126 determines the initial schedule. The initial schedule may include a range of dates for the plurality of services to be completed according to the availability of the client, prerequisites, and/or the like.

In operation 1306, a bidding process is performed to assign one or more contractors to the plurality of services. The bidding process can comprise enabling a plurality of contractors to submit bids for the one or more services, evaluating received bids based at least in part on contractor availability and the initial schedule, and assigning the one or more contractors to the plurality of services based on the evaluation. Performing the bidding process can further comprise recommending to the one or more contractors to submit bids for the plurality of services based at least in part on contractor availability.

In operation 1308, a schedule is determined for the one or more contractors to complete the services. Determining the schedule for the one or more contractors can comprise determining one or more prerequisites for the plurality of services, and determining the schedule so the one or more prerequisites will be satisfied.

In operation 1310, the status of the services is monitored. Monitoring the status of the services can comprise requesting an update from a contractor of the one or more contractors to indicate a milestone has been completed, receiving evidence to show the milestone has been completed from the contractor, and evaluating the evidence. When determining the evidence does not indicate milestone has been completed, the method 1300 can further comprise determining a service cannot be performed until the milestone is completed and adjusting the schedule so the milestone is scheduled to be completed before the service is scheduled to be performed. The evidence may be a photograph, a video, and/or the like. The method 1300 can further comprise monitoring one or more installed systems associated with the client; and based on the monitoring, (i) recommending an adjustment to the operation of an installed system of the one or more installed systems, (ii) recommending installation of a new system, (iii) recommending replacement of an existing system of the one or more installed systems, or (iv) any combination of (i)-(iii).

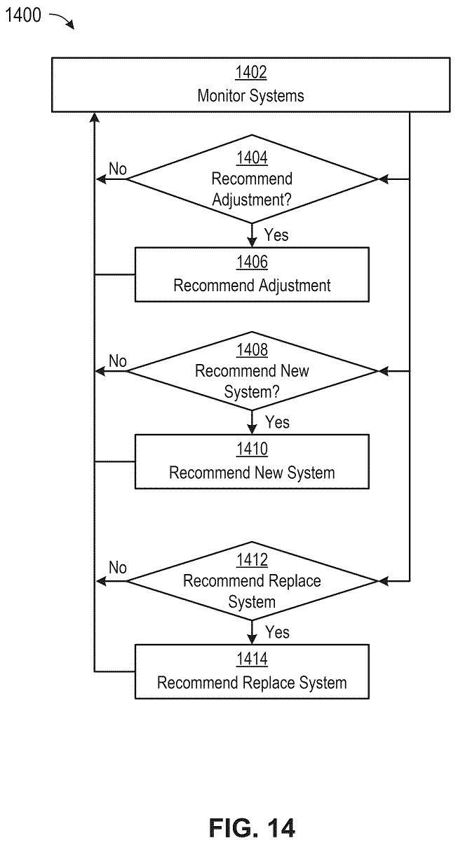

FIG. 14 is a flow chart of a method 1400 for monitoring and managing systems in accordance with aspects of the present disclosure. The method 1400 can comprise monitoring systems in operation 1402. For example, the energy management system 102 monitors systems associated with a client. Based on the monitoring, the energy management system 102 can determine whether to recommend an adjustment to the operation of a system in decision 1404. The method 1400 proceeds to operation 1406 and the adjustment is recommended when it is determined to make the recommendation. Based on the monitoring, the energy management system 102 can also determine whether to recommend a new system in decision 1408. The method 1400 proceeds to 1410 and the new system is recommended when it is determined to make the recommendation. Based on the monitoring, the energy management system 102 can further determine whether to recommend a replacement system in decision 1412. The method 1400 proceeds to 1414 and the replacement system is recommended when it is determined to make the recommendation.

FIG. 15 is a block diagram of a computing device 1500. As shown in FIG. 15, computing device 1500 may include a processing unit 1510 and a memory unit 1515. The memory unit 1515 may include a software module 1520 and a database 1525. While executing on the processing unit 1510, software module 1520 may perform, for example, processes for environmental analysis and energy system planning, installation scheduling, and management with respect to FIGS. 1-13. Computing device 1500, for example, may provide an operating environment for the energy management system 102, the external systems 104, the user devices 106, and the like. The energy management system 102, the external systems 104, the user devices 106, and the like may operate in other environments and are not limited to computing device 1500.

Computing device 1500 may be implemented using a Wi-Fi access point, a tablet device, a mobile device, a smart phone, a telephone, a personal computer, a network computer, a mainframe, a router, a switch, a server cluster, a network storage device, a network relay device, or other similar microcomputer-based device. Computing device 1500 may comprise any computer operating environment, such as hand-held devices, multiprocessor systems, microprocessor-based or programmable sender electronic devices, minicomputers, mainframe computers, and the like. Computing device 1500 may also be practiced in distributed computing environments where tasks are performed by remote processing devices. The aforementioned systems and devices are examples, and computing device 1500 may comprise other systems or devices.

FIG. 16 illustrates an implementation of a communications device 1600 that may implement one or more of the energy management system 102, the external systems 104, the user devices 106, etc., of FIGS. 1-13. In various implementations, the communications device 1600 may comprise a logic circuit. The logic circuit may include physical circuits to perform operations described for one or more of the energy management system 102, the external systems 104, the user devices 106, etc., of FIGS. 1-13, for example. As shown in FIG. 16, the communications device 1600 may include one or more of, but is not limited to, a radio interface 1610, baseband circuitry 1630, and/or the computing device 1500.

The communications device 1600 may implement some or all of the structures and/or operations for the energy management system 102, the external systems 104, the user devices 106, etc., of FIGS. 1-13, storage medium, and logic circuit in a single computing entity, such as entirely within a single device. Alternatively, the communications device 1600 may distribute portions of the structure and/or operations using a distributed system architecture, such as a client station server architecture, a peer-to-peer architecture, a master-slave architecture, etc.

A radio interface 1610, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 1610 may include, for example, a receiver 1615 and/or a transmitter 1620. The radio interface 1610 may include bias controls, a crystal oscillator, and/or one or more antennas 1625. In additional or alternative configurations, the radio interface 1610 may use oscillators and/or one or more filters, as desired.

The baseband circuitry 1630 may communicate with the radio interface 1610 to process, receive, and/or transmit signals and may include, for example, an Analog-To-Digital Converter (ADC) for down converting received signals with a Digital-To-Analog Converter (DAC) 1635 for up converting signals for transmission. Further, the baseband circuitry 1630 may include a baseband or Physical (PHY) layer processing circuit for the PHY link layer processing of respective receive/transmit signals. Baseband circuitry 1630 may include, for example, a Media Access Control (MAC) processing circuit 1640 for MAC/data link layer processing. Baseband circuitry 1630 may include a memory controller for communicating with MAC processing circuit 1640 and/or a computing device 1500, for example, via one or more interfaces 1645.

In some configurations, PHY processing circuit may include a frame construction and/or detection module, in combination with additional circuitry such as a buffer memory, to construct and/or deconstruct communication frames. Alternatively or in addition, MAC processing circuit 1640 may share processing for certain of these functions or perform these processes independent of PHY processing circuit. In some configurations, MAC and PHY processing may be integrated into a single circuit.

Referring to the above process generally, it is noted that certain aspects may be performed in different orders. Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

The example embodiments described herein may be implemented using hardware, software, or a combination thereof and may be implemented in one or more computer systems or other processing systems. However, the manipulations performed by these example embodiments were often referred to in terms, such as entering, which are commonly associated with mental operations performed by a human operator. No such capability of a human operator is necessary in any of the operations described herein. Rather, the operations may be completely implemented with machine operations. Useful machines for performing the operation of the example embodiments presented herein include general purpose digital computers or similar devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium.

More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general-purpose computer or in any other circuits or systems.

Embodiments of the disclosure may be practiced via a system-on-a-chip (SOC) where each or many of the elements described herein (e.g., the elements of the energy management system 102) may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 1500 on the single integrated circuit (chip).

From a hardware standpoint, a CPU typically includes one or more components, such as one or more microprocessors, for performing the arithmetic and/or logical operations required for program execution, and storage media, such as one or more memory cards (e.g., flash memory) for program and data storage, and a random-access memory, for temporary data and program instruction storage. From a software standpoint, a CPU typically includes software resident on a storage media (e.g., a memory card), which, when executed, directs the CPU in performing transmission and reception functions. The CPU software may run on an operating system stored on the storage media, such as, for example, UNIX or Windows, iOS, Linux, and the like, and can adhere to various protocols such as the Ethernet, ATM, TCP/IP protocols and/or other connection or connectionless protocols. As is well known in the art, CPUs can run different operating systems, and can contain different types of software, each type devoted to a different function, such as handling and managing data/information from a particular source or transforming data/information from one format into another format. It should thus be clear that the embodiments described herein are not to be construed as being limited for use with any particular type of server computer, and that any other suitable type of device for facilitating the exchange and storage of information may be employed instead.

A CPU may be a single CPU, or may include plural separate CPUs, wherein each is dedicated to a separate application, such as, for example, a data application, a voice application, and a video application. Software embodiments of the example embodiments presented herein may be provided as a computer program product, or software, which may include an article of manufacture on a machine accessible or non-transitory computer-readable medium (i.e., also referred to as “machine readable medium”) having instructions. The instructions on the machine accessible or machine-readable medium may be used to program a computer system or other electronic device. The machine-readable medium may include, but is not limited to, optical disks, CD-ROMs, and magneto-optical disks or other type of media/machine readable medium suitable for storing or transmitting electronic instructions. The techniques described herein are not limited to any particular software configuration. They may find applicability in any computing or processing environment. The terms “machine accessible medium”, “machine readable medium” and “computer-readable medium” used herein shall include any non-transitory medium that is capable of storing, encoding, or transmitting a sequence of instructions for execution by the machine (e.g., a CPU or other type of processing device) and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

While various example embodiments have been described above, it should be understood that they have been presented by way of example, and not limitation. It will be apparent to persons skilled in the relevant art(s) that various changes in form and detail can be made therein. Thus, the present invention should not be limited by any of the above-described example embodiments but should be defined only in accordance with the following claims and their equivalents.

What is claimed is:

1. A method comprising:
determining a plurality of services for a client;
determining an initial schedule to perform the plurality of services based at least in part on an availability of the client;
performing a bidding process to assign one or more contractors to the plurality of services, the bidding process comprising:
enabling a plurality of contractors to submit bids for the plurality of services,
evaluating received bids based at least in part on contractor availability and the initial schedule, and
assigning the one or more contractors to the plurality of services based on the evaluation;
determining a schedule for the one or more contractors to complete the plurality of services; and
monitoring a status of the plurality of services.

2. The method of claim 1, wherein determining the schedule for the one or more contractors comprises:
determining one or more prerequisites for the plurality of services; and
determining the schedule so the one or more prerequisites will be satisfied.

3. The method of claim 1, wherein performing the bidding process further comprises:
recommending to the one or more contractors to submit bids for the plurality of services based at least in part on the contractor availability.

4. The method of claim 1, wherein determining the plurality of services for the client comprises:
receiving client information and building information;
determining one or more recommended services based on the client information and the building information, wherein the client is operable to select the plurality of services from any one of (i) the one or more recommended services, (ii) one or more available services, or (iii) both (i) and (ii); and
receiving authorization from the client to proceed with the plurality of services.

5. The method of claim 1, wherein monitoring the status of the plurality of services comprises:
requesting an update from a contractor of the one or more contractors to indicate a milestone has been completed;
receiving evidence to show the milestone has been completed from the contractor; and
evaluating the evidence.

6. The method of claim 5, further comprising, when determining the evidence does not indicate the milestone has been completed:
determining a service cannot be performed until the milestone is completed; and
adjusting the schedule so the milestone is scheduled to be completed before the service is scheduled to be performed.

7. The method of claim 5, wherein the evidence is (i) a photograph, (ii) a video, or (iii) both (i) and (ii).

8. The method of claim 1, further comprising:
monitoring one or more installed systems associated with the client; and
based on the monitoring, (i) recommending an adjustment to operation of an installed system of the one or more installed systems, (ii) recommending installation of a new system, (iii) recommending replacement of an existing system of the one or more installed systems, or (iv) any combination of (i)-(iii).

9. The method of claim 1, wherein determining the plurality of services for the client further comprises:
maintaining real-time information of available financing offers and rebate offers;
sharing the real-time information of available financing offers and rebate offers with the client; and
receiving one or more selections of financing offers and rebate offers associated with the plurality of services.

10. The method of claim 1, wherein determining the plurality of services for the client comprises:
receiving job information;
determining one or more recommended service parameters based on the job information;
estimating costs and a completion time based on the one or more recommended service parameters;
proposing the one or more recommended service parameters, the costs, and the completion time to the client; and
receiving approval from the client.

11. A system comprising:
a memory storage; and
a processing unit coupled to the memory storage, wherein the processing unit is operative to:
determine a plurality of services for a client;
perform a bidding process to assign one or more contractors to the plurality of services, the bidding process comprising to:
enable a plurality of contractors to submit bids for the plurality of services,
evaluate received bids based at least in part on contractor availability and an availability of the client, and
assign the one or more contractors to the plurality of services based on the evaluation;
determine a schedule for the one or more contractors to complete the plurality of services; and
monitor a status of the plurality of services.

12. The system of claim 11, wherein to determine the schedule for the one or more contractors comprises to:
determine one or more prerequisites for the plurality of services; and
determine the schedule so the one or more prerequisites will be satisfied.

13. The system of claim 11, wherein to perform the bidding process further comprises to:
recommend to the one or more contractors to submit bids for the plurality of services based at least in part on the contractor availability.

14. The system of claim 11, wherein to determine the plurality of services for the client comprises to:
receive job information;
determine one or more recommended service parameters based on the job information;
estimate costs and a completion time based on the one or more recommended service parameters;
propose the one or more recommended service parameters, the costs, and the completion time to the client; and
receive approval from the client.

15. The system of claim 11, wherein to monitor the status of the plurality of services comprises to:
request an update from a contractor of the one or more contractors to indicate a milestone has been completed;
receive evidence to show the milestone has been completed from the contractor; and
evaluate the evidence.

16. An energy management system, comprising:
a job creation engine operable to determine a plurality of services for a client;
a job assignment engine operable to:
perform a bidding process to assign one or more contractors to the plurality of services, the bidding process comprising to:
enable a plurality of contractors to submit bids for the plurality of services,
evaluate received bids based at least in part on contractor availability and an availability of the client, and
assign the one or more contractors to the plurality of services based on the evaluation; and
determine a schedule for the one or more contractors to complete the plurality of services; and
a job tracking engine operable to monitor the plurality of services.

17. The energy management system of claim 16, wherein to determine the schedule for the one or more contractors comprises to:
determine one or more prerequisites for the plurality of services; and
determine the schedule so the one or more prerequisites will be satisfied.

18. The energy management system of claim 16, wherein to perform the bidding process further comprises to:
recommend to the one or more contractors to submit bids for the plurality of services based at least in part on the contractor availability.

19. The energy management system of claim 16, wherein to determine the plurality of services for the client comprises to:
receive job information;
determine one or more recommended service parameters based on the job information;
estimate costs and a completion time based on the one or more recommended service parameters;
propose the one or more recommended service parameters, the costs, and the completion time to the client; and
receive approval from the client.

20. The energy management system of claim 16, wherein to monitor the plurality of services comprises to:
request an update from a contractor of the one or more contractors to indicate a milestone has been completed;
receive evidence to show the milestone has been completed from the contractor; and
evaluate the evidence.
